(19) United States
(12) Patent Application Publication
(10) Pub. No.: US 2013/0023367 A1
(43) Pub. Date: Jan. 24, 2013

(54) TENSIONING ARRANGEMENT HAVING A SWINGING ARM

(71) Applicant: George L. Markley, Montour Falls, NY (US)

(72) Inventor: George L. Markley, Montour Falls, NY (US)

(73) Assignee: BorgWarner Inc., Auburn Hills, MI (US)

(21) Appl. No.: 13/639,538

(22) PCT Filed: Apr. 12, 2011
(86) PCT No.: PCT/US11/32006

§ 371 Date: Oct. 5, 2012

Related U.S. Application Data
(60) Provisional application No. 61/324,341, filed on Apr. 15, 2010.

(51) Int. Cl. F16H 7/08

(52) U.S. Cl. 474/111

(57) ABSTRACT

An apparatus (10) for imparting tension to at least one strand of an endless loop power transferring member (12) encircling a drive sprocket (14) and at least one driven sprocket (16a, 16b). At least one moveable tensioning arms (18a, 18b) is pivotable about fixed pins (26a, 26b) on at least two swing arms (20a, 20b), and support an inwardly facing shoe (20a, 20b) with a power-transferring-member-sliding face (22a, 22b). In a multi-strand tensioning configuration, a link assembly (60) can include at least two link members (32a, 32b) pivotally connected to one another at respective first ends (40a, 40b) and constrained for limited movement along a fixed slot (36) extending generally along a centerline of the endless loop power transferring member (12) between the drive sprocket (14) and the driven sprockets (16a, 16b). The two link members (32a, 32b) are pivotally connected individually to opposite ones of the two spaced apart tensioning arms (18a, 18b) at second locations (42a, 42b).

### FIELD OF THE INVENTION

The invention relates to a tensioning system for imparting tension to a power transferring member or chain encircling a driving sprocket and at least one driven sprocket, and more particularly, to a tensioner that simultaneously tensions multiple strands of the power transferring member or chain.

### BACKGROUND

Chain tensioners in engines are used to control the power transmission chains as the chain travels around a plurality of sprockets. The slack of the chain varies as the temperature in an engine increases and as the chain wears. When a chain wears, the chain elongates and the slack in the chain increases. The increase in slack may cause noise, slippage, or tooth jumping between the chain and the sprocket teeth. If the increase of the slack of the chain is not taken up, by a tensioner for example, in an engine with a chain driven camshaft, the engine may be damaged because the camshaft timing is misaligned by several degrees due to slippage or tooth jumping.

Various configurations for closed loop chain tensioner systems are known from U.S. Pat. No. 7,476,168: U.S. Pat. No. 7,429,226; U.S. Pat. No. 6,955,621; U.S. Pat. No. 6,322,470; U.S. Pat. No. 3,856,101; U.S. Pat. No. 2,210,276; French Patent No. 2,832,358; and Japanese Patent No. 2002-089,636. While each of these configurations is satisfactory for performing its intended function, several of these configurations provide restricted space and location sites for the tensioner driver. It would be desirable to provide a tensioning system that overcomes these limitations, and that provides additional benefits as described below.

### SUMMARY

A tensioning system imparts tension to an endless loop power transferring member encircling a drive sprocket and at least one driven sprocket. The system can include at least one tensioning arm, at least two swing arms, and a tension driver mechanism. Each tensioning arm can have an upper pivot location and a lower pivot location for movement along a predetermined path about corresponding upper and lower pivot pins, and a shoe with a power-transferring-member-sliding face. A swing arm can be pivotally connected to each of the upper and lower pivot locations of each tensioning arm at one end and pivotally connected to a fixed pivot pin at an opposite end to define a predetermined path of travel for the tensioning arm. The tension driver mechanism can engage a tensioning aim directly or indirectly, through one of the swing arms in a single or dual tensioning arm configuration, or through a link assembly in a dual tensioning arm configuration.

A slot body can be provided in a dual tensioning arm configuration with the slot body rigidly fixed to secure the slot with outer ends pointing generally toward the sprockets and somewhat central to and inside the endless loop power transferring member. A free moving pin can be retained in the slot, and pivotally constrained to the first end of each of a pair of link members, restricting the movement of the first ends of both link members to that defined by the slot. Each tensioning arm can include a link location, possibly corresponding to the upper pivot location but not necessarily so, for pivotally attachment of the second end of a corresponding link member.

A swing arm can include an outwardly extending protrusion from the fixed pivot pin location and spaced angularly from the pivot location of tensioning arm. The protrusion can extend outwardly from the fixed pivot pin a distance nearly equidistant with a distance from the fixed pivot pin to the pivot location of the tensioning arm. A tension driver mechanism can operably engage the protrusion for driving a tensioning arm, or in combination with a link assembly for driving first and second tensioning aims, in movement toward a centerline of and into sliding engagement with the endless loop power transferring member.

A link end of a first tensioning arm can be pivotally attached to a link member with a lever extension The lever extension can extend outwardly from the pivotal attachment a distance nearly equidistant with a distance from the first end of the link member to the pivotal attachment. A tension driver mechanism can operably engage the lever extension for driving first and second tensioning arms in movement toward a centerline of and into sliding engagement with the endless loop power transferring member.

The tension driver mechanism can have a rigidly fixed housing for receiving an outwardly spring biased piston with an end in contact with a tensioning arm, or a pad near an end of the lever extension of the elongate link member, or a pad near an end of the protrusion of a swing arm. When the piston of the tension driver mechanism is biased outwards from the housing, the end of the piston applies force to the tensioning arm, or the pad, creating a pivoting movement at the link end of the tensioning arm. When used in combination with a pair of tensioning arms and a link assembly, the pivoting movement of the first tensioning arm can force the first link end of both link members to move within the slot of the slot body, while moving the second tensioning arm toward the centerline of the power transferring member in a tensioning manner. Being that the first end of both link members are pivotally attached together, the other link member also moves in the slot and move the second tensioning arm toward the centerline of the power transferring member, thereby tensioning the power transferring member nearly simultaneously and nearly equally on both strands. The power transferring member, the sprockets, the tension driver mechanism and the spring loading of the tensioning arm shoe can be of any conventional configuration.

Other applications will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a front view of a timing system including a tensioning arrangement having an endless loop of belt or chain, a drive sprocket, at least one driven sprocket, at least one tensioning arm, at least two swing arms, and a tension driver mechanism,

FIG. 2 is a perspective or isometric view of the tensioning arrangement of FIG. 1 with the endless loop of belt or chain, the drive sprocket, the at least one driven sprocket, at least one tensioning arm, at least two swing arms, and the tension driver mechanism;

FIG. 3 is a front view of a timing system including a multi-strand tensioning arrangement having an endless loop of belt or chain, a drive sprocket, at least one driven sprocket, at least two tensioning arms, at least four swing arms, a link assembly and a tension driver mechanism;

FIG. 4 is a perspective or isometric view of the multi-strand tensioning arrangement of FIG. 3 with the endless loop of belt or chain, the drive sprocket, the at least one driven sprocket, at least two tensioning arms, at least four swing arms, a link assembly, and the tension driver mechanism;

FIG. 5 is a front view of a timing system including a multi-strand tensioning arrangement having an endless loop of belt or chain, a drive sprocket, at least one driven sprocket, at least two tensioning arms, at least four swing arms, a link assembly, and a tension driver mechanism;

FIG. 6 is a front view of a timing system including a multi-strand tensioning arrangement having an endless loop of belt or chain, a drive sprocket, at least one driven sprocket, at least two tensioning arms, at least four swing arms, where one swing arm has a protrusion, a link assembly, and a tension driver mechanism; and

FIG. 7 is a front view of a timing system including a multi-strand tensioning arrangement having an endless loop of belt or chain, a drive sprocket, at least one driven sprocket, at least two tensioning arms, at least four swing arms, a link assembly, where on link member has a lever extension, and a tension driver mechanism.

### DETAILED DESCRIPTION

The term “belt” or “chain”, as used interchangeably herein, is any power transferring member forming an endless loop and constructed of flexible material or of articulated rigid links to permit the member to conform to a radius of curvature of a pulley or sprocket drive face and intended, in use, to be driven in an endless path; and, by contact with the pulley or sprocket drive face, to transmit power to or extract power from the pulley or sprocket. The term a “pulley” or “sprocket”, as used interchangeably herein, is a device rotatable about an axis and having a drive face radially spaced from the axis of rotation for intended power transferring engagement with a belt or chain to drive the belt or chain on an endless path or to extract power from the belt or chain to drive an output load device. The term “guide roll” as used herein is a device rotatable about an axis and having a belt or chain-contacting face radially spaced from the axis of rotation for intended engagement with the belt or chain to aid in directing the belt or chain along an intended path of travel. A guide roll, as distinguished from a pulley or sprocket, is not intended to provide driving power to, or extract power from, a belt or chain. The term “tensioning aim” as used herein is a member other than a pulley or sprocket engageable with a belt or chain, and which is adjustable or relatively movable with respect to the belt or chain in a direction which causes an increase or decrease in tensile stress in the belt or chain or a take-up or any undesirable belt or chain slack to maintain a desirable drive traction between the belt or chain and the pulley or sprocket drive face. A tensioning arm, as distinguished from a guide roll, has a non-rotatable face portion for contacting the belt or chain, whereby the belt or chain slides over the face portion of the tensioning arm. The term “tension drive mechanism” as used herein applies a force for actuating the multi-strand tensioning arrangement and is derived from or transmitted via electrical energy or the exertion of force on a fluid.

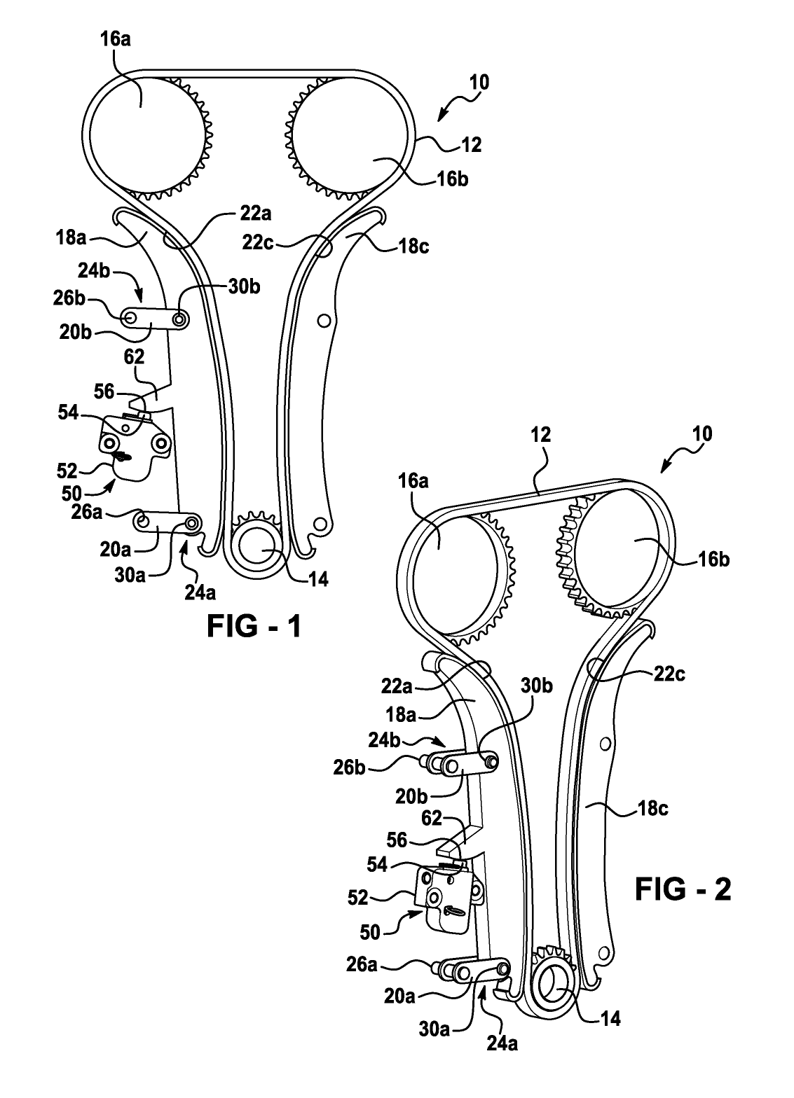

FIGS. 1 and 2 illustrate a tensioning arrangement or apparatus 10 including an endless loop power transferring member 12, by way of example and not limitation such as a belt or a chain, wrapped around a drive sprocket 14 and at least one driven sprocket 16a, 16b supported from a drive shaft and a driven shaft respectively. The continuous endless loop power transferring member 12 can encircle the drive pulley or sprocket 14 to fix one part of a path of the continuous endless loop power transferring member 12, while the at least one driven pulley or sprocket 16a, 16b can fix another part of the path of the continuous endless loop power transferring member 12. A guide roll can also be provided if desired. On the outside of at least one of the taut strand and the slack strand of the power transferring member 12 is a moveable tensioning arm 18a. A stationary tensioning arm 18c on the opposite strand can be provided, if desired. Each of the tensioning arms 18a, 18c can have a compliant face assembly including a wrap around shoe with a power-transferring-member sliding surface 22a, 22c extending along a significant length of the arm. Each shoe can be spring loaded with a blade type spring positioned within a pocket of the complaint face assembly, if desired. The spring can be located between the tensioning arm 18a, 18c and the corresponding shoe deforming the shoe away from the tensioning arm.

The moveable tensioning arm 18a has a first pivot location end 24a and a second pivot location end 24b for rotation about a corresponding pivot pin 30a, 30b. A swing arm 20a, 20b is pivotally connected to each pivot pin 30a, 30b of the moveable tensioning arm 18a with an opposite end of each swing arm pivotally connected to a corresponding fixed pivot pin 26a, 26b. The swing arms 20a, 20b defining a predetermined path of movement for the moveable tensioning arm 18a.

The moveable tensioning arm 18a can include an outwardly extending actuation lever 62. A tension driver mechanism 50 can have a rigidly fixed housing 52 for receiving an outwardly spring biased piston 54 with an end 56 in contact with the tensioning arm 18a directly or indirectly. The end 56 of the spring biased piston 54 can engage with the outwardly extending actuation lever 62 associated with the tensioning arm 18a. When the piston 54 of the tension driver mechanism 50 is biased outwards from the fixed housing 52, the end 56 of the piston 54 applies force to tensioning arm 18a driving the tensioning arm 18a toward a centerline of and into sliding engagement with the endless loop power transferring member 12. The endless loop power transferring member 12, the drive sprocket 14, the driven sprockets 16a, 16b, the tension driver mechanism 50, and spring loading of the tensioning arm shoes can be of any desired conventional configuration.

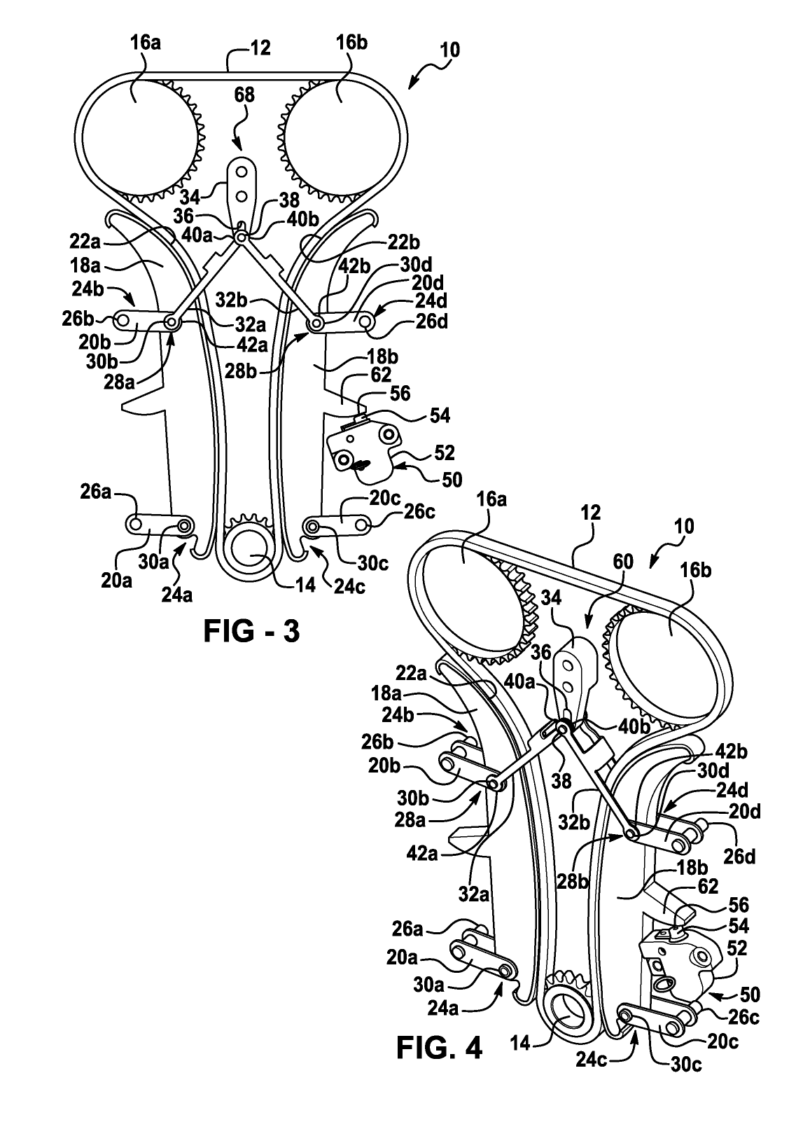

Referring now to FIGS. 3 and 4, the tensioning arrangement or apparatus 10 is similar to that illustrated and described with respect to FIGS. 1 and 2, with the exception of replacing the stationary tensioning arm 18c with a moveable tensioning arm 18b. FIGS. 3 and 4 illustrates a multi-strand tensioning arrangement 10 having an endless loop power transferring member 12, by way of example and not limitation, such as a belt or a chain, a drive sprocket 14, at least one driven sprocket 16a, 16b, at least two moveable tensioning arms 18a, 18b, at least two swing arms 20a, 20b, 20c, 20d, a link assembly 60, and a tension driver mechanism 50. Each moveable tensioning arm 18a, 18b can include a link location 28a, 28b which can correspond with a location for a corresponding pivot pin 30a, 30b, 30c, 30d, but not necessarily so, for attaching link members 32a, 32b that are free to rotate with the pins 30a, 30b, 30c, 30d located outside the endless loop power transferring member strands between the drive sprocket 14 and the at least one driven sprocket 16a, 16b.

Inside the endless loop power transferring member strands, and preferably along a centerline (i.e. a line spaced equidistant between the two strands of the endless loop power transferring member), is a rigidly fixed body 34 defiling a slot 36 with outer ends extending generally between the drive sprocket 14 and at least one driven sprocket 16a, 16b. The fixed body 34 is located generally central to and inside of the endless loop power transferring member 12 best seen in FIGS. 3-7. A free moving pin 38 is retained in the slot 36 and is pivotally constrained to the first end 40a of the link member 32a and the first end 40b of the link member 32b, restricting the movement of both first ends 40a, 40b of the link members 32a, 32b to that defined by the slot 36. The link end 28a of the first tensioning aim 18a is pivotally attached to a second end 42a of the link member 32a. The link end 28b of the second tensioning arm 18b is pivotally attached to the second end 42b of the link member 32b.

The tension driver mechanism 50 can have a rigidly fixed housing 52 for receiving an outwardly spring biased piston 54 with an end 56 in contact with one of the moveable tensioning arms 18a, 18b. When the piston 54 of the tension driver mechanism 50 is biased outwards from the fixed housing 52, the end 56 of the piston 54 applies force to engaged moveable tensioning arm 18a or 18b creating a pivoting movement at the link end 30a or 30b of the engaged tensioning arm 18a or 18b, forcing both connected first ends 40a, 40b of the link members 32a, 32b to move within the slot 36 of the fixed body 34 while moving the other tensioning arm 18a or 18b toward the power transferring member centerline in a tensioning manner. Being that the first end 40b of the link member 32b is pivotally attached to the first end 40a of the link member 32a, the link member 32b also moves in the slot 36 of the fixed body 34 and moves the other tensioning arm 18a, 18b toward the power transferring member centerline thereby tensioning the power transferring member 12 nearly simultaneously and nearly equally on both strands.

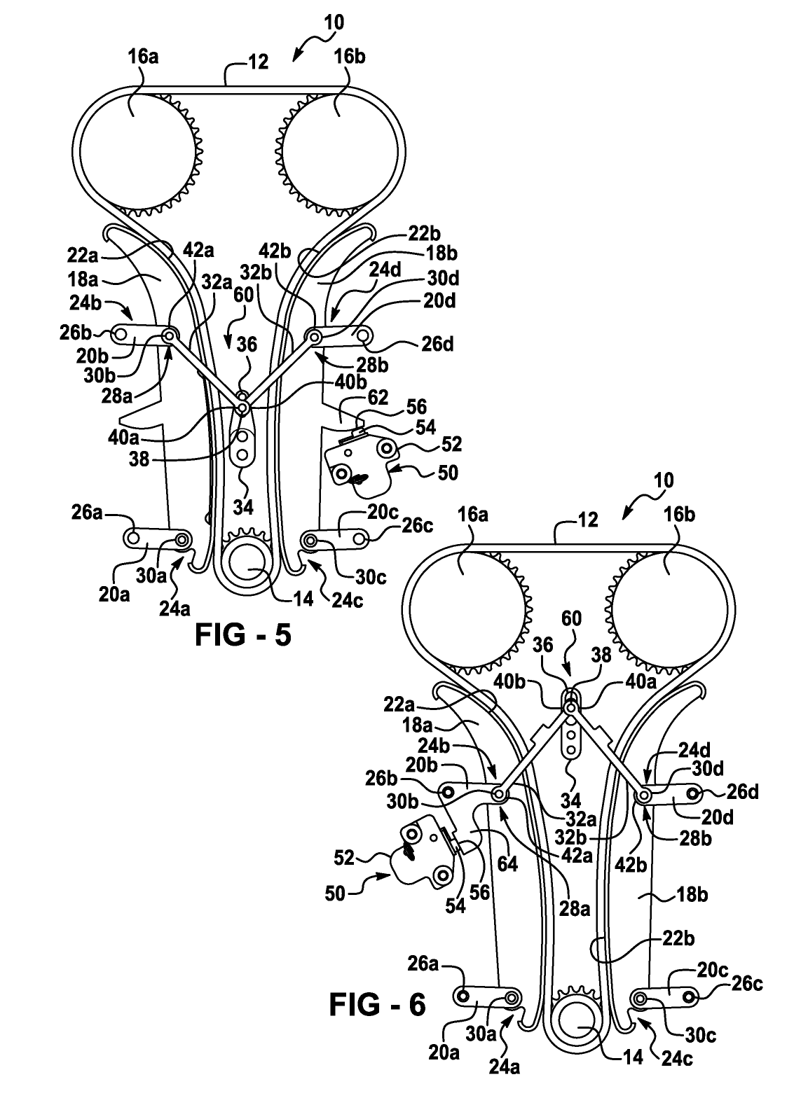

Referring briefly to FIG. 5, the tensioning arrangement or apparatus 10 is similar to that illustrated and described with respect to FIGS. 3 and 4 with the exception of inverting the link assembly 60 and the rigidly fixed body 34. It should be recognized that the rigidly fixed body 34, slot 36, pin 38, and link members 32a, 32b can be located in either the orientation shown in FIGS. 3-4, and 6-7, or the orientation shown in FIG. 5 for any of the configurations shown in FIGS. 3-7. in either case, when the piston 54 of the tension driver mechanism 50 is biased outwards from the fixed housing 52, the end 56 of the piston 54 applies force to engaged moveable tensioning arm 18a or 18b creating a pivoting movement at the link end 28a or 28b of the engaged tensioning arm 18a or 18b, forcing the pin 38 and both pivotally connected first ends 40a, 40b of the link members 32a, 32b to move within the slot 36 of the fixed body 34, while moving the other tensioning arm 18a or 18b toward the power transferring member centerline in a tensioning manner. Being that the first end 40b of the link member 32b is pivotally attached to the first end 40a of the link member 32a, the link member 32b also moves in the slot 36 of the fixed body 34 and moves the other tensioning arm 18a or 18b toward the power transferring member centerline thereby tensioning the power transferring member 12 nearly simultaneously and nearly equally on both strands.

Referring now to FIG. 6, the tensioning arrangement or apparatus 10 is similar to that illustrated and described with respect to FIGS. 3-5 with the exception of relocating the tension driver mechanism 50 to engage one of the swing arms 20a, 20b, 20c, 20d instead of engaging one of the tensioning arms 18a, 18b. By way of example and not limitation, one of the swing arms 20b can include an outwardly extending protrusion 64 from the fixed pivot pin location 26b and spaced angularly from the pivot location 30b of tensioning arm 18a. The protrusion 64 can extend outwardly from the fixed pivot pin 26b a distance nearly equidistant with a distance from the fixed pivot pin 26b to the pivot location 30b of the tensioning arm 18a. A tension driver mechanism 50 can operably engage the protrusion 64 for driving a tensioning arm 18a, or in combination with a link assembly 60 for driving first and second tensioning arms 18a, 18b, in movement toward a centerline of and into sliding engagement with the endless loop power transferring member 12. It should be recognized that the tension driver mechanism 50 can engage any one of the swing arms 20a, 20b, 20c, or 20d without departing from the spirit and scope of the present disclosure, which is not limited to the particular swing arm location illustrated in FIG. 6. In a single strand tensioning apparatus, the piston 54 of the tension driver mechanism 50 is biased outwards from the fixed housing 52, the end 56 of the piston 54 applies force to the engaged swing arm 20a or 20b or 20c or 20d creating a pivoting movement at the link end 28a or 28b of the corresponding moveable tensioning arm 18a or 18b. In a dual strand tensioning apparatus, the piston 54 of the tension driver mechanism 50 is biased outwards from the fixed housing 52, the end 56 of the piston 54 applies force to the engaged swing arm 20a or 20b or 20c or 20d creating a pivoting movement at the link end 28a or 28b of the corresponding moveable tensioning arm 18a or 18b, forcing the pin 38 and both pivotally connected first ends 40a, 40b of the link members 32a, 32b to move within the slot 36 of the fixed body 34, while moving the other tensioning arm 18a or 18b toward the power transferring member centerline in a tensioning manner. Being that the first end 40b of the link member 32b is pivotally attached to the first end 40a of the link member 32a, the link member 32b also moves in the slot 36 of the fixed body 34 and moves the other tensioning arm 18a or 18b toward a centerline of the power transferring member 12 thereby tensioning the power transferring member 12 nearly simultaneously and nearly equally on both strands.

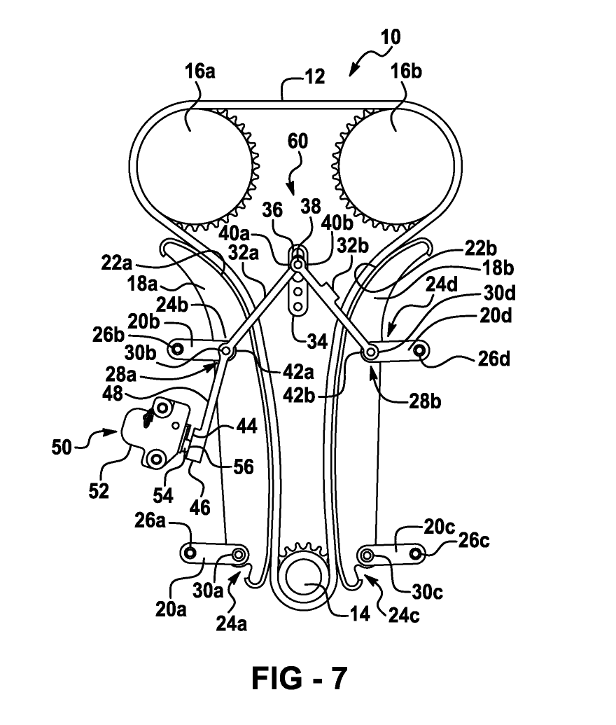

Referring now to FIG. 7, the tensioning arrangement or apparatus 10 is similar to that illustrated and described with respect to FIGS. 3-6 with the exception of relocating the tension driver mechanism 50 to engage a lever extension 48 formed on one of the link members 32a, 32b. By way of example and not limitation, the lever extension 48 can be formed on the link member 32a extending outwardly from a generally centrally located pivot position 30b can be approximately equidistant from the first end 40a and from a pad 44 located near an outer end 46 of the lever extension 48 of the elongate link member 32a. The tension driver mechanism 50 can have a rigidly fixed housing 52 for receiving an outwardly spring biased piston 54 with an end 56 in contact with a pad 44 near the end 46 of the lever extension 48 of the elongate link member 32a. When the piston 54 of the tension driver mechanism 50 is biased outwards from the fixed housing 52, the end 56 of the piston 54 applies force to the pad 44 and a pivoting moment at the link end of the first arm 18a, forcing the first end 40a of the elongate link member 32a with a lever extension 48 to move within the slot 36 of the fixed body 34 while moving the second tensioning arm 18b toward a centerline of the power transferring member in a tensioning manner. Being that the first end 40b of the link member 32b is pivotally attached to the first end 40a of the elongate link member 32a with a lever extension 48, the link member 32b also moves in the slot 36 of the fixed body 34 and moves the second tensioning arm 18b toward the centerline of the power transferring member 12 thereby tensioning the power transferring member 12 nearly simultaneously and nearly equally on both strands.

The tension driver mechanism 50 can include a piston 54 biased outwardly from a fixed housing 52 by a spring, a pressurized fluid or some combination of the two. The tension driver mechanism 50 is the source of force that causes the primary tensioning of the power transferring member 12. Any movement creates a pivoting motion at the link end 28a of the first tensioning arm 18a. This pivoting causes the slot-constrained pin 38 to freely move along the slot 36 driving the first end 40a of the elongate link member 32a in an inward movement of the link end 28a of the first tensioning arm 18a. The slot-constrained pin 38 movement within slot 36 of the pinned first ends 40a, 40b causes an inward movement of the link end 28b of the second tensioning aim 18b. The inward movement of the link ends 28a, 28b of the first and the second tensioning arms 18a, 18b causes tensioning of the power transferring member 12. The slot body 34 limits the sidewise motion of the first ends 40a, 40b and the clocking of the driven sprockets 16a, 16b. The lever extension 48 can increase or multiply the motion of the piston 54 of the tension driver mechanism to better insure pumping up of the hydraulic tensioner and allows location of the tension driver mechanism outside of the endless loop of chain 12. The tension driver mechanism force is applied to position the tensioning arm of one strand, preferentially with the other tensioning arm following. A spring loaded shoe in the tensioning arm 18a, 18b can provide for localized strand tensioning, supplementing the limited tensioning arm 18a, 18b motion due to the two tensioning arms 18a, 18b being linked together, or for an intentionally softened tensioner spring. Spring loading of the tensioning shoe is optional, if desired. The link members 32a with lever extension 48 and tension driver mechanism 50 can be located on an opposite side from that illustrated, i.e. these elements can swap sides in order to locate the tension driver mechanism on either the tight strand or the slack strand side. The tension driver mechanism 50 can be hydraulic with damping and a ratchet, or with just a spring (no hydraulics) and/or no ratchet. Additional driven sprockets to those illustrated can also be added, if desired. The tensioning arms 18a, 18b, link members 32a, 32b, slot defining fixed body 34, and tension driver mechanism 50 can be inverted, if desired. It should also be recognized that the blade type spring between the body of the tensioning arms 18a, 18b and the corresponding shoes could be eliminated, eliminating the compliant face assembly. The multi-strand tensioning arrangement 10 can be used for any drive with a drive pulley or sprocket 14 and at least one driven pulley or sprocket 16a, 16b.

The elongate link member 32a with a lever extension 48 has a body of two lengths, each emanating outwardly a distance from a generally centrally located pivot position 30b for pivotally attaching to the link end 28a of the first tensioning arm 18a. The distance emanated from the pivot position 30a can be approximately equal between the first end 40a and the pad 44 adjacent the outer end 46 of the lever extension 48, or can be of unequal lengths if desired.

The tension driver mechanism 50 can include an outwardly spring biased piston 54 extending outwardly from a rigidly fixed housing 52, drawing the tensioning arms 18a, 18b together towards a centerline of the power transferring member 12, tensioning or squeezing the strands of the power transferring member 12 between the tensioning arms 18a, 18b equally and simultaneously. By linking the tensioning arms 18a, 18b together the vibrations of one strand is linked to the other strand and the vibrations are generally neutralized. By linking the tensioning arms 18a, 18b together to a single tension driver mechanism 50, the force is divided equally between both tensioning arms 18a, 18b when the strands are equal. Since the tensioning arms 18a, 18b are connected, if one strand of the chain tightens, the other strand slackens. The total tensioning force is applied to resist the tightening strand.

The multi-strand tensioning arrangement also allows for the additional tensioning necessary to tension a worn, elongated power transferring member 12. Since the tensioning arms 18a, 18b are connected and tensioning the power transferring member strand is equal and simultaneous between the two tensioning arms 18a, 18b, the increase in power transferring member length is equally absorbed in each power transferring member strand, maintaining the timed relationship of the drive sprocket 14 and driven sprockets 16a, 16b throughout the life of the power transferring member, eliminating the need to compensate for the change in sequential timing due to power transferring member elongation and enhancing the engine performance over its lifetime. To tension an elongated, worn power transferring member 12, the tension driver mechanism 50 can be activated to extend outwards from the rigidly fixed housing 52, causing the opposing tensioning arms 18a, 18b to be drawn further in toward the centerline of the power transferring member 12 and the rigidly fixed body 34, squeezing or tensioning the slack and taut strand portions of the power transferring member 12 simultaneously and nearly equally.

In the illustration of FIG. 7, a rigidly fixed body 34 defining a slot 36 is provided, one link member 32a includes a lever extension 48 extending past a pivot position 42a providing a pad 44 outside the loop of power transferring member 12 allowing the tension driver mechanism to be moved outside the endless loop power transferring member 12. The slot 36 in the slot body 34 constrains the first end or ends 40a, 40b of the link members 32a, 32b thereby restricting driven cam sprocket 16a, 16b clocking by restricting the unitized swing of the two tensioning arms 18a, 18b about respective pivot pin 26a, 26b, 26c, 26d. The lever extension 48 and pad 44 can provide a moment arm nearly equal to a distance between the two pin locations 40a, 30a and can nearly double the motion of the pin 38 constrained to the slot 36 contributing to improved pump-up of the multi-strand tensioner arrangement 10. The illustrated configuration allows increased freedom in the selection of a location for the tension drive mechanism 50.

An apparatus 10 imparts tension to multiple strands of a power transferring member 12 forming an endless loop to conform to a radius of curvature of spaced apart devices 14, 16a, 16b rotatable about respective spaced apart axes. Each device 14, 16a, 16b has a drive face radially spaced from the axis of rotation for intended power transferring engagement of the power transferring member 12 between the spaced apart devices 14, 16a, 16b. The apparatus can include two tensioning arms 18a, 18b spaced apart from one another at respective outer ends 28a, 28b for movement independent of one another. The two tensioning arms 18a, 18b support inwardly facing shoes with power-transferring-member-sliding faces 22a, 22b. A link assembly 60 includes at least two link members 32a, 32b pivotally connected to one another at respective first ends 40a, 40b. The connected first ends 40a, 40b are constrained for limited movement along a fixed slot 36 extending generally along a centerline of the endless loop power transferring member 12 between the spaced apart devices 14, 16a, 16b. The at least two link members 32a, 32b are pivotally connected individually to outer ends 28a, 28b of opposite ones of the two spaced apart tensioning arms 18a, 18b at second locations 42a, 42b spaced from the first ends 40a, 40b. One of the two link members 32a, 32b can include a lever extension 48 extending outwardly from the second location 42a to be engageable with a tension driver 50 for driving the link assembly 60 and connected tensioning arms 18a, 18b in motion for tensioning the power transferring member 12 nearly simultaneously and nearly equally on both strands.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In a tensioning system (10) for imparting tension to an endless loop power transferring member (12) encircling a drive sprocket (14) and at least one driven sprocket (16a, 16b), the improvement comprising:
at least one moveable tensioning arm (18a, 18b), each moveable tensioning arm having a first pivot location end (24a, 24c) and a second pivot location end (24b, 24d) for rotation with respect to a corresponding pivot pin (30a, 30b, 30c, 30d);
at least two swing arms (20a, 20b, 20c, 20d), each swing arm (20a, 20b, 20c, 20d) pivotally connected at one end to the corresponding pivot pin (30a, 30b, 30c, 30d) and pivotally connected at an opposite end to a corresponding fixed pivot pin (26a, 26b, 26c, 26d) for defining a predetermined path of movement for the at least one moveable tensioning arm (18a, 18b); and
a tension driver (50) for driving the at least one moveable tensioning aim (18a, 18b) toward a centerline of the endless loop power transferring member (12) into tension imparting engagement with the endless loop power transferring member (12).

2. The improvement of claim 1 further comprising:
a stationary tensioning arm (18c) located opposite from the at least one moveable tensioning arm (18a, 18b) for operably engaging an opposite strand of the endless loop power transferring member (12).

3. The improvement of claim 1, wherein the tension driver (50) is engageable with the at least one moveable tensioning arm (18a, 18b).

4. The improvement of claim 1 further comprising:
a protrusion (64) formed on at least one of the swing arms (20a, 20b, 20c, 20d) extending outwardly from the corresponding fixed pivot pin location (26a, 26b, 26c, 26d) and spaced angularly from the corresponding pivot location (30a, 30b, 30c, 30d) of the corresponding connected moveable tensioning arm (18a, 18b).

5. The improvement of claim 4, wherein the tension driver (50) is engageable with the protrusion (64).

6. The improvement of claim 1, wherein the at least one moveable tensioning arm (18a, 18b) further comprises a first moveable tensioning arm (18a) and a second moveable tensioning arm (18b).

7. The improvement of claim 6 further comprising:
a link assembly (60) including two link members (32a, 32b) pivotally connected to one another at respective first ends (40a, 40b), the connected first ends (40a, 40b) constrained for limited movement along a fixed slot (36) extending generally along a centerline of the endless loop power transferring member (12) extending between the drive sprocket (14) and the at least one driven sprocket (16a, 16b), the two link members (32a, 32b) pivotally connected individually to outer opposite ends (28a, 28b) of the two spaced apart moveable tensioning arms (18a, 18b) at second locations (42a, 42b) spaced from the first ends (40a, 40b).

8. The improvement of claim 7, wherein the tension driver (50) is engageable with one of the first and second moveable tensioning arms (18a, 18b).

9. The improvement of claim 7 further comprising:
a protrusion (64) formed on at least one of the swing arms (20a, 20b, 20c, 20d) extending outwardly from the corresponding fixed pivot pin location (26a, 26b, 26c, 26d) and spaced angularly from the corresponding pivot location (30a, 30b, 30c, 30d) of the corresponding connected moveable tensioning arm (18a, 18b); and
wherein the tension driver (50) is engageable with the protrusion (64).

10. The improvement of claim 7 further comprising:
a lever extension (48) formed on one of the two link members (32a) extending outwardly from the second location (42a) to be engageable with the tension driver (50); and
wherein the tension driver (50) is engageable with the lever extension (48).

11. An apparatus (10) for imparting tension to multiple strands of an endless loop power transferring member (12) to conform to a radius of curvature of spaced apart devices (14, 16a, 16b) rotatable about respective spaced apart axes of rotation, and each device (14, 16a, 16b) having a drive face radially spaced from an axis of rotation for intended power transferring engagement of the endless loop power transferring member (12) between the spaced apart devices (14, 16a, 16b), the apparatus comprising:
at least one moveable tensioning arm (18a, 18b), each moveable tensioning arm having a first pivot location end (24a, 24c) and a second pivot location end (24b, 24d) for rotation with respect to a corresponding pivot pin (30a, 30b, 30c, 30d);
at least two swing arms (20a, 20b, 20c, 20d) for each tensioning arm (18a, 18b), each swing arm (20a, 20b, 20c, 20d) pivotally connected at one end to the corresponding pivot pin (30a, 30b, 30c, 30d) and pivotally connected at an opposite end to a corresponding fixed pivot pin (26a, 26b, 26c, 26d) for defining a predetermined path of movement for the at least one moveable tensioning arm (18a, 18b);
a protrusion (64) formed on at least one of the swing arms (20a, 20b, 20c, 20d) extending outwardly from the corresponding fixed pivot pin location (26a, 26b, 26c, 26d) and spaced angularly from the corresponding pivot location (30a, 30b, 30c, 30d) of the corresponding connected moveable tensioning arm (18a, 18b); and
a tension driver (50) engaging the protrusion (64) for driving the corresponding connected moveable tensioning arm (18a, 18b) in motion for tensioning the endless loop power transferring member (12) nearly simultaneously and nearly equally on both strands.

12. The apparatus of claim 11, wherein the protrusion (64) extends outwardly from the corresponding fixed pivot pin (26a, 26b, 26c, 26d) a distance nearly equidistant with a distance from the corresponding fixed pivot pin (26a, 26b, 26c, 26d) to the corresponding pivot location (30a, 30b, 30c, 30d) of the corresponding connected moveable tensioning arm (18a, 18b).

13. The apparatus of claim 11, wherein the at least one moveable tensioning arm (18a, 18b) further comprises a first moveable tensioning aim (18a) and a second moveable tensioning arm (18b).

14. The apparatus of claim 13 further comprising:
a link assembly (60) including at least two link members (32a, 32b) pivotally connected to one another at respective first ends (40a, 40b), the connected first ends (40a, 40b) constrained for limited movement along a fixed slot (36) extending generally along a centerline of the endless loop power transferring member (12) between the spaced apart devices (14, 16a, 16b), the at least two link members (32a, 32b) pivotally connected individually to outer opposite ends (28a, 28b) of the first and second moveable tensioning arms (18a, 18b) at second locations (42a, 42b) spaced from the first ends (40a, 40b), a lever extension (48) formed on one of the two link members (32a) extending outwardly from the second location (42a) to be engageable with the tension driver (50); and
wherein the tension driver (50) is engageable with the lever extension (48).

15. In an apparatus (10) for imparting tension to multiple strands of an endless loop power transferring member (12) to conform to a radius of curvature of spaced apart devices (14, 16a, 16b) rotatable about respective spaced apart axes of rotation, and each device (14, 16a, 16b) having a drive face radially spaced from an axis of rotation for intended power transferring engagement of the endless loop power transferring member (12) between the spaced apart devices (14, 16a, 16b), the improvement comprising:
two moveable tensioning arm (18a, 18b) spaced apart from one another for movement with respect to one another, each moveable tensioning arm having a first pivot location end (24a, 24c) and a second pivot location end (24b, 24d) for rotation with respect to a corresponding pivot pin (30a, 30b, 30c, 30d);
two swing arms (20a, 20b, 20c, 20d) for each of the two tensioning arms (18a, 18b), each swing arm (20a, 20b, 20c, 20d) pivotally connected at one end to the corresponding pivot pin (30a, 30b, 30c, 30d) and pivotally connected at an opposite end to a corresponding fixed pivot pin (26a, 26b, 26c, 26d) for defining a predetermined path of movement for the corresponding connected moveable tensioning arm (18a, 18b);
a link assembly (60) including two link members (32a, 32b) pivotally connected to one another at respective first ends (40a, 40b), the connected first ends (40a, 40b) constrained for limited movement along a fixed slot (36) extending generally along a centerline of the endless loop power transferring member (12) between the spaced apart devices (14, 16a, 16b), the two link members (32a, 32b) pivotally connected individually to outer opposite ends (28a, 28b) of the two moveable tensioning arms (18a, 18b) at second locations (42a, 42b) spaced from the first ends (40a, 40b); and
a tension driver (50) for driving the link assembly (60) and connected tensioning arms (18a, 18b) in motion for tensioning the endless loop power transferring member (12) nearly simultaneously and nearly equally on both strands.
